(19) United States
(12) Patent Application Publication
(10) Pub. No.: US 2005/0017125 A1
(43) Pub. Date: Jan. 27, 2005

(54) Kite and assembly connector

(76) Inventor: Don Tabor, Imperial Beach, CA (US)

Correspondence Address: LOUIS J BACHAND, PO BOX 1508, LA CANADA, CA, 91012, US

(21) Appl. No.: 10/618,239

(22) Filed: Jul. 11, 2003

(51) Int. Cl. B64C 39/00

(52) U.S. Cl. 244/10

(57) ABSTRACT

The present invention provides for a connector used in a kite, including two or more legs with a first end and a second end, and a junction portion coupled adjacent the first end of the two or more legs, forming a saddle portion therebetween.

### BACKGROUND OF THE INVENTION

1. Field of the Invention

This invention relates generally to kites and assembly elements for kites.

2. Description of the Related Art

The past and current state of technology in the field of kite building has long moved away from the traditional two dimensional diamond frame to more elaborate three dimensional designs such as kites in the shape of airplanes, space crafts, fanciful animals, among many other imaginative figures. However, there are certain disadvantages in creating kites having elaborate designs, including difficulty in assembling a complex three-dimensional structure, which typically includes a number of stiff rods fitted through notches provided on the fabric or synthetic lining of the kite.

### SUMMARY OF THE INVENTION

The present invention provides a new connector for kites, and kites utilizing the connector which have a unique and flexible design and are simple to handle. According to one embodiment, the assembly connector is flexible and includes a junction piece and two or more connector legs adjoining the junction piece, each of the connector legs being attachable to a rod of the kite.

Additionally, the assembly connector may be fitted through an aperture or aperture on the airfoil or lining of the kite, enabling a stable structure wherein the lining is supported by the connector, and exerts a force on the connector opposite the force exerted by the kite rods. As a result, a kite in accordance with the present invention utilizes less rods and has a lighter frame, making it less vulnerable to breakage in transit and during assembly and operation, and more suitable for construction of smaller kites.

### OBJECTS OF THE INVENTION

It is an object of the present invention to provide a new assembly connector for kites comprising a junction piece and connector legs adjoining the junction piece.

It is a further object of the present invention to provide a new assembly connector for kites which includes a junction piece and connector legs adjoining the junction piece, which allows for support of a lining of the kite.

It is an object of the present invention to provide a new assembly connector for kites which is flexible and lightweight, yet durable and stable.

It is a further object of the invention to provide kites having a unique construction utilizing an assembly connector, which joins two or more rods of the kite, and may be fitted through an aperture in the lining of the kite, whereby the lining exerts a force on the connector opposite the force exerted by the rods.

Other objects and advantages of the present invention will be apparent from a review of the following specification and accompanying drawings.

### BRIEF DESCRIPTION OF THE DRAWINGS

FIG. 1 is a perspective view of a kite having a six point “star” design.

FIG. 2 is a perspective view of a connector in accordance with one embodiment of the present invention.

FIG. 3 is a sectional view of the connector of FIG. 2, taken along line 3-3.

FIG. 4 is a view similar to FIG. 2, wherein the openings on the legs of the connector can be seen.

FIG. 5 is a perspective view of a kite similar to the kite of FIG. 1, but having a five point star design.

FIG. 6 is a perspective view of a kite having a “ship” design, and utilizing two of the five point star kites shown in FIG. 5.

FIG. 7 is a perspective view of a connector in accordance with another embodiment of the present invention.

FIG. 8 is a perspective view of a kite having an “airplane” design and including the connector of FIG. 2.

### DESCRIPTION OF THE PREFERRED EMBODIMENT(S)

The detailed description set forth below in connection with the appended drawings is intended as a description of presently preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

The present invention provides a new assembly connector for kites, and kites utilizing the new assembly connector. While certain kite designs utilizing the new connector are illustrated in the figures, this invention contemplates kites of a variety of different designs.

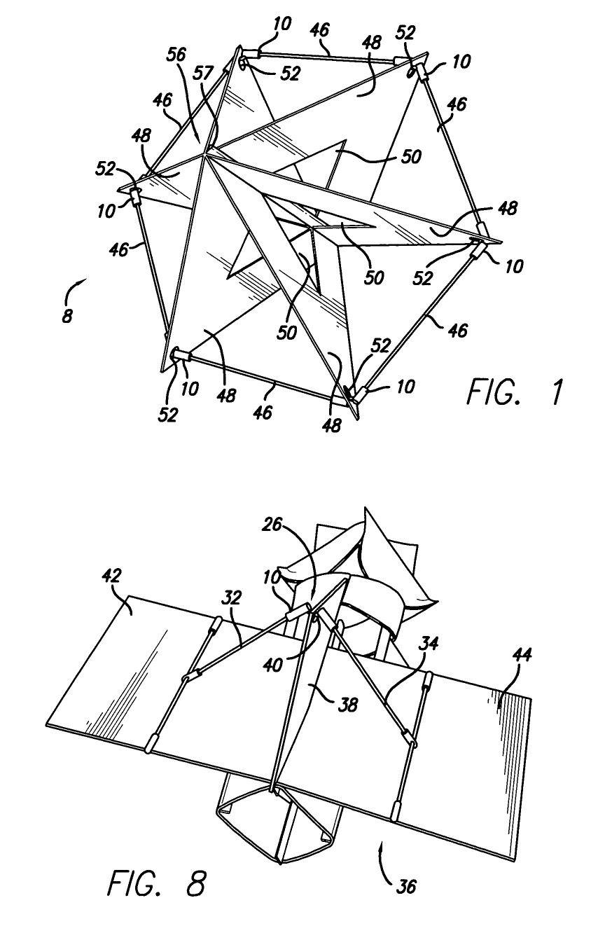

FIG. 1 shows a kite according to one embodiment of the present invention, generally at 8. Kite 8 typically includes a connector 10 that is coupled to a rod 46 to create the framework of kite 8. Kite 8 further includes airfoil portions 48 that are configured to couple to connector 10 as well as each other to form the body of the kite.

Airfoil potions 48 are typically configured to include edges that define apertures 52 that are formed to couple to connector 10, such that airfoil portions 48 create a force inwardly towards the center of the kite, and opposing the force created by the coupling of connector 10 and rod 46. Preferably, a metal ring outlines the aperture 52 of the airfoil portion 48, but other configurations may be used, as desired, including a sewn hem around the aperture.

Kite 8 also typically includes a pole 56 and center pole cover 57 that are configured to couple to airfoil portions 48 to form the center of the kite and make the kite more rigid. The kite, including pole 56 and airfoil portions 48, but not including the rods 46 and connectors 10, preferably form one unit, with the pole 56 being sewn inside a center pole cover 57. With this configuration, the kite may be shipped in a relatively small, and generally two-dimensional package. The kite may then be easily assembled before use.

Furthermore, airfoil portions 48 are typically coupled at the sides opposite the connector 10 to center pole cover 57, or to each other to form the kite. Coupling is typically accomplished by stitching the elements together, however, other configurations may be utilized, as desired. It will be appreciated that other configurations may be utilized to form the interior of the kite, as desired.

Airfoil portions 48 are typically made of nylon fabric or other materials used for kite making, but could be other materials, as desired. Rods 46 are typically rigid plastic, but may be wood or other materials, as desired. With this new connector and kite configuration, sturdy, small, lightweight and durable three-dimensional kites may be easily assembled, disassembled, and provide many fanciful designs not currently possible.

According to a preferred embodiment, the kite 8 is designed on a miniature scale, weighing approximately 0.1 to 1 oz. and more particularly about 0.5 oz., and having dimensions of approximately 3×3×3 to 12×12×12 inches, and more particularly 7.5×7.5×7.5 inches. It will be appreciated that many other dimensions and configurations may be utilized, as desired.

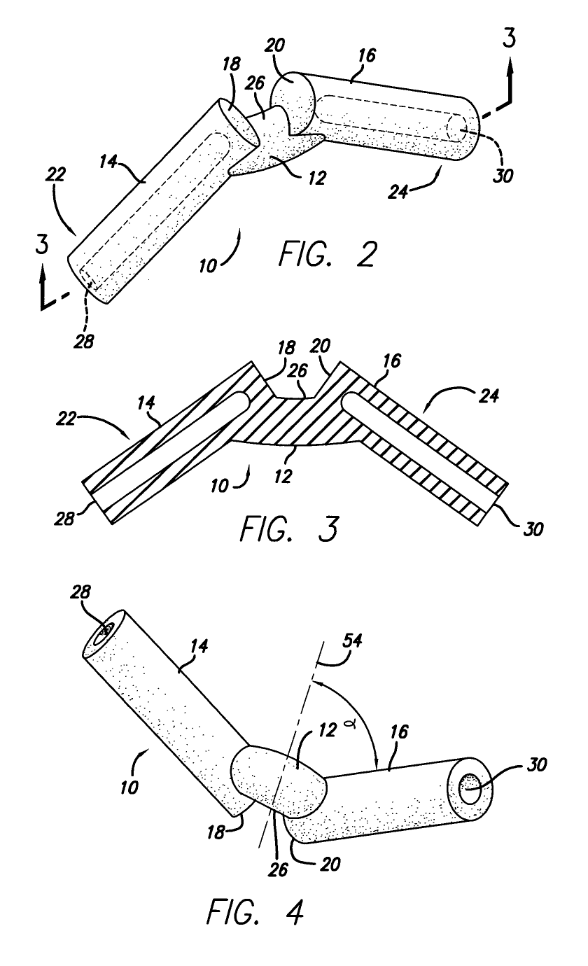

FIG. 2 shows a detailed view of a connector 10 according to one embodiment of the present invention. The assembly connector 10 comprises a junction portion 12 and two or more legs adjoining the junction portion 12, each of the legs having orifices into which a rod can be inserted, to couple them. The legs of the connector, together with the junction portion form a saddle portion 26, which provides a support point for the airfoil or lining of the kite.

The legs 14 and 16 are typically coupled adjacent or near their first ends 18 and 20 of the junction portion, leaving a saddle portion 26 between the first ends 18 and 20 of the legs 14 and 16, which is particularly advantageous in constructing the kite, as will be described in more detail below. Additionally, orifices 28 and 30 are typically included at second ends 22 and 24 of each of the legs 14 and 16 for receiving the end of a rod to form portions of the kite.

The connector is preferably made of a flexible, elastomer-type material such as rubber, or plastic, such that it is flexible and lightweight, yet durable. This enables the angle between the legs 14 and 16 to naturally adjust to an angle necessary for constructing a kite of a particular frame design, making assembly and disassembly very easy, and also provides an extra degree of flexibility during transport, flight and landing.

During assembly of a kite, any one of the legs may be inserted through the aperture 52, and, depending on the size of the inserted leg, insertion and placement of the aperture in a saddle portion may be aided by bending and/or compression of the legs.

In the assembled state, the legs 14 and 16 and rods 46 provide generally upward tension on the assembly connector 10, and the airfoil portions 48 provides downward tension. The overall structure is stable, keeping the aperture 52 firmly engaged within the saddle, as the top region of the aperture engages the top surface of the junction portion 12, with the first ends 18 and 20 of the legs 14 and 16, generally above the aperture 52, thus preventing the connector 10 from slipping out of the aperture 52.

Since the connectors are flexible, the kite 8 may be easily assembled and disassembled with minimal bending of the rods. Additionally, the structure and design of the kite may force each of the connectors into an angle, other than the fabricated angle, between the legs of the connector, despite the fabricated angle. The flexibility of the connectors further enables the kite structure to fold into a two-dimensional compact configuration, then be easily transformed into the star design, with minimal assembly required.

For a miniature kite, legs 14 and 16 are typically 0.25-1.0 inches long and 0.015-0.25 inches in diameter. Junction portion 12 is typically 0.015-0.25 inches long. It will be appreciated that although these dimensions are for miniature kites, other dimensions may be utilized, as desired.

FIGS. 1, 5 and 6 illustrate kites utilizing a star shape, and the connector 10. One example of a star shaped kite 8 utilizing six connectors is shown in FIG. 1. The kite 8 includes six equal length rods 46 which form a hexagonal configuration. The kite 8 further includes six similar triangular airfoil portions 48 having inner triangular cutouts 50 centrally joined by a pole 56 and center pole cover 57. Each of the airfoil portions 48 may have an aperture 52 through which one of the connectors is inserted, where each aperture 52 is engaged within the saddle portion 26 formed between the legs 14 and 16 and junction portion 12. Thus, each airfoil portion 48 is tautly stretched between the pole 56 and center pole cover 57 and a connector to form the star-like design, whereby two rods and connector exert an outward force, and a airfoil portion 48 exerts an inward force, opposing the outward force such that the kite design is stable. It will be appreciated that although airfoil portions are shown as generally triangular with a cut-out piece, many other geometries and configurations may be utilized, as desired.

FIG. 3 shows a cross-section along lines 3-3 of the connector shown in FIG. 2. FIG. 3 shows orifices 28 and 30 at the second ends 22 and 24 of legs 14 and 16, which are configured to receive rods 46 to form the framework of the kite. Again legs 14 and 16, and junction portion 12 are configured to form a saddle portion 26, that is configured to receive an airfoil portion of a kite.

FIG. 4 is a perspective view from the underside of the connector of FIG. 2. Legs 14 and 16 are typically symmetrical about central axis 54, and form an angle α from a central axis 54. Connector 10 is typically formed symmetrically about central axis 54, but other configurations may be utilized, as desired.

Saddle portion 26 is configured to receive portions of the airfoil of the kite, such that the airfoil will exert force opposing the force exerted by the combination of connector 10 and rods 46.

Furthermore, a connector that is formed of this type of material and configuration to help maintain coupling with the rods, via a friction or interference fit, or other configuration. The assembly connector 10 may be fabricated with the legs 14 and 16, forming any desired angle α with respect to a central axis 54 of the junction portion 12, and though the legs are preferably symmetrical with respect to the central axis 54 of the junction portion 12, they may each form a different angle α with the junction piece axis. Furthermore, connector 10 may also be oriented with a twist, or with the legs skewed, or other configurations, as desired. Different embodiments may include a connector having any number of legs extending from the junction portion(s), wherein the legs may be oriented at any desired angle or with a twist with respect to one another, or other configurations, as desired, depending on the kite design.

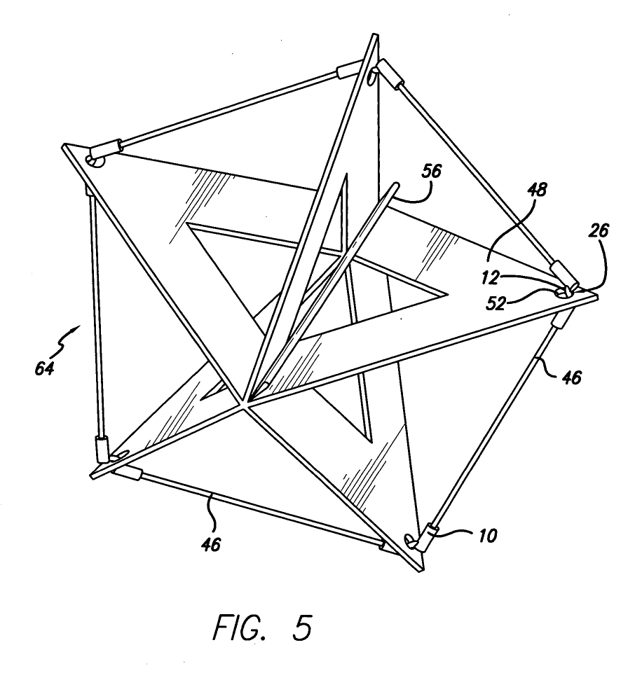

FIG. 5 shows a five-pointed star kite of the present invention, generally at 64. Kite 64 typically includes a connector 10 that has a junction portion 12 that forms a saddle portion 26 of which an aperture 52 of airfoil portion 48 couples to such that the force exerted by the airfoil is opposite that exerted by rod 46 and connector 10.

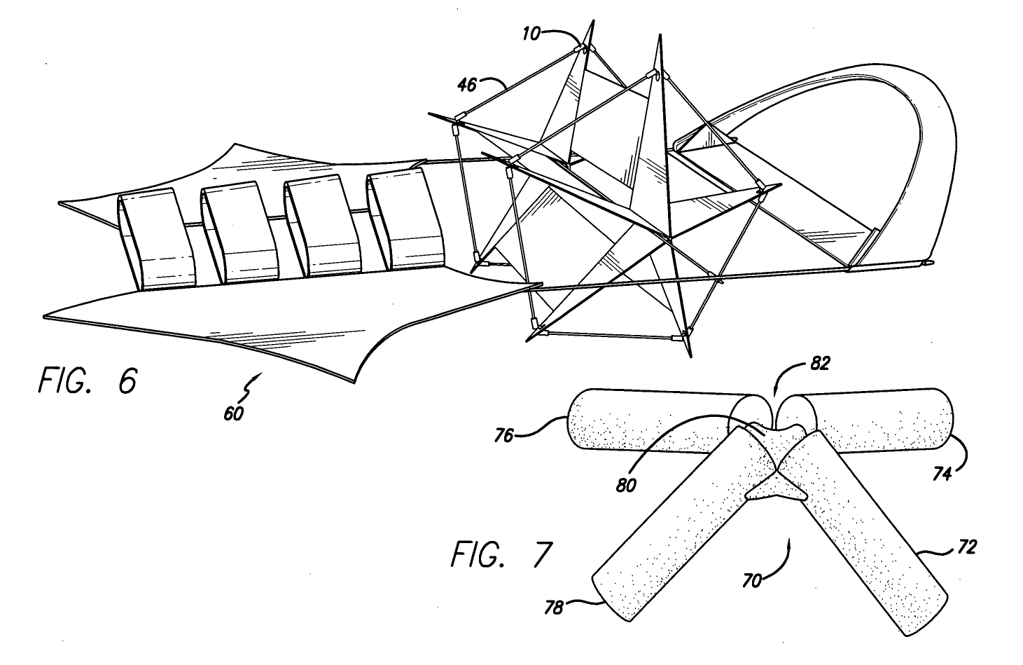

FIG. 6 shows an air ship kite according to another embodiment of the present invention, generally at 60. Kite 60 utilizes the five-star kite configuration shown in FIG. 5 to form a paddle wheel-like portion of kite 60. It will be appreciated that this configuration may be utilized to form many different kite, toy and chemical model configurations, as desired.

FIG. 7 is a connector 70 according to another embodiment of the present invention. Connector 70 typically includes four legs 72, 74, 76 and 78 that are coupled together via a junction portion 80 that forms a saddle portion 82 that may allow a portion of an airfoil to fit onto, thus creating a design that will be durable, flexible and easy to assemble and disassemble. In assembly of a kite using this connector, two adjacent legs are inserted through an aperture in a lining of the kite, wherein the lining is held in place between two pairs of legs and rods on opposite sides of the lining.

Although the connector legs are illustrated in the figures as cylindrical, it should be understood that other geometries such as triangular, square, hexagonal, octagonal, and other configurations, may also be utilized. Furthermore, the legs on one connector may vary in length with respect to one another and other numbers of legs may be utilized, as desired. Furthermore, the legs may be configured skewed from each other, and may connect to junction portion in other configurations.

A kite 36 having an airplane design is illustrated in FIG. 8, wherein an assembly connector 10 is used to join first and second rods 32 and 34 to each other at an approximately right angle. The kite 36 includes an airfoil portion 38 forming a “fin-like” structure, and having an aperture 40 through which the assembly connector 10 is inserted, whereby the aperture 40 is engaged within the saddle portion 26 of the assembly connector 10.

The rods 32 and 34 are firmly held in position between the wings 42 and 44, which may be supported by the rods 32 and 34, and/or supported independent of the rods. Though the wings 42 and 44 are illustrated as being held in a leveled position, the wings may also be angled upwards or downwards depending on the length of the rods and angle of the legs 14 and 16 of the assembly connector 10.

A “fin” as illustrated for the kite 36 of FIG. 4 can be incorporated into kites of various designs including stars, animals, fish, ships, surfboards, and the like.

According to a preferred embodiment, the kite 36 is designed on a miniature scale, weighing approximately 0.1 to 2 oz and more particularly 0.3 oz, and having dimensions of approximately 3×3 to 10×10 inches, and more particularly 7×7 inches, wherein the length of the center pole is approximately 7 inches, and the length of each of the rods 32 and 34 is approximately 3.5 inches. It will be appreciated that other dimensions and configurations may be utilized, as desired.

The connector of the present invention allows for a lighter frame since it provides a support point for the airfoil or lining of the kite, thereby reducing the number of rods needed. Such lightweight frame is ideal for smaller sized or miniaturized kites. The flexibility of the connector further reduces bending tension on the rods, and enables easier assembly and disassembly, fold up, and storage, and makes the kite more resistant to breaking and damage during storage, transport, and flight. The flexibility of the connector is further ideal for miniaturized kites as shorter rods are generally more rigid and lightweight.

The connector of the present invention may further be suitable for use with toys, in particular construction toys, and molecular chemistry/biology sets, including molecular models, and the like.

While the present invention has been described with regards to particular embodiments, it is recognized that additional variations of the present invention may be devised without departing from the inventive concept.

1. A connector for a kite having spaced apart airfoil portions supported by two or more rods defining a kite frame, said connector comprising a junction portion having a saddle engageable with a said airfoil portion, and extending from said junction portion two or more legs open to receive said rods and relatively angled to maintain said airfoil portions in their said spaced apart relation.

2. The connector according to claim 1, including also a kite airfoil portion and in which said connector junction portion saddle engages said kite airfoil portion.

3. The connector according to claim 2, in which said kite airfoil portion is apertured, said connector junction saddle being received within said aperture to have its said legs on opposite sides of said airfoil portion.

4. The connector according to claim 2, in which said airfoil portion is apertured, and said connector junction saddle portion engages said airfoil portion aperture.

5. The connector according to claim 1, in which said connector comprises an elastomer.

6. The connector according to claim 1, in which each said rod exerts a force on said connector opposing a force exerted on said connector by a said airfoil portion.

7. The connector according to claim 1, in which said two or more legs are flexibly coupled to said junction portion at an angle and at an orientation that varies with forces exerted upon said junction portion by a said airfoil portion and said rods.

8. The connector according to claim 1, wherein said connector is flexible.

9. The connector according to claim 1, wherein said connector is symmetrical about a central axis.

10. In combination: The connector according to claim 1, and a flying toy having frame rods and an airfoil portion supported thereby.

11. A kite, comprising:
a connector including two or more legs and a junction portion configured to form a saddle portion; and
two or more rods that couple to said two or more legs of said connector; and
an airfoil portion supported by said rods and comprising one or more edges that define at least one aperture;
wherein least one of said apertures engages said saddle portion.

12. The kite according to claim 11, in which said connector is flexible.

13. The kite according to claim 11, wherein said rods and said airfoil portion exert opposing forces on said connector.

14. The kite according to claim 13, wherein said two or more legs are coupled to said junction portion at an angle and an orientation, said connector being flexible such that said angle and said orientation varies with said forces exerted upon it by said airfoil and said rods.

15. A kite comprising:
an airfoil portion having one or more edge apertures;
a connector including two or more legs coupled by a junction portion, thereby forming a saddle region; and
an airfoil portion supporting rod coupled to each of said two or more legs;
wherein one or more of said edge apertures are engaged with said saddle portion, said airfoil portion and said rods exerting opposing forces on said connector.

16. The kite according to claim 15, in which said connector comprises a flexible material.

17. A method of assembling a kite having a frame comprising at least one rod and an airfoil portion supported by said frame, including:
inserting a connector having a saddle through an aperture defined in said airfoil portion of the kite such that said airfoil portion engages said saddle portion of said connector;
connecting said connector to said at least one rod; and
orienting said engaged airfoil portion to exert a force on said connector that is opposed by a force exerted by said connected rod on said connector.
